(19) United States
(12) Patent Application Publication
(10) Pub. No.: US 2013/0103302 A1
(43) Pub. Date: Apr. 25, 2013

(54) ELECTRONIC MAP CREATION PROCESS

(71) Applicants: Stephen T'siobbel, Merelbeke (BE); Edwin Bastiaensen, Beersel (BE); Theo Kamalski, Weert (NL)

(72) Inventors: Stephen T'siobbel, Merelbeke (BE); Edwin Bastiaensen, Beersel (BE); Theo Kamalski, Weert (NL)

(21) Appl. No.: 13/806,223

(22) PCT Filed: Dec. 22, 2010
(86) PCT No.: PCT/EP2010/070458

§ 371 Date: Dec. 21, 2012

Related U.S. Application Data
(60) Provisional application No. 61/357,579, filed on Jun. 23, 2010.

(51) Int. Cl. G01C 21/00

(52) U.S. Cl. CPC G01C 21/005
USPC 701/409

(57) ABSTRACT

An electronic map generation process is provided comprising the steps of: 1) Obtaining a local electronic map via a communication system, the local electronic map having been generated by a horizon generator in a vehicle and output to the communication system, the horizon generator having used a source electronic map and vehicle position data from a vehicle positioning system to generate the local electronic map; 2) Processing the local electronic map in an electronic map generation unit; and 3) Outputting an electronic map.

### FIELD OF THE INVENTION

The present invention relates to mapping. More specifically, but not necessarily exclusively, the present invention relates to electronic map creation and also to electronic map error detection processes and corresponding systems.

### BACKGROUND TO THE INVENTION

A recent innovation in vehicle safety is the introduction of Advanced Driver Assistance Systems (ADAS). ADAS applications generally provide advice to a vehicle user and or take action in view of potential or actual hazards. By way of example some ADAS applications adjust headlight position, some cause a vehicle to break, others prepare the vehicle and user(s) to mitigate an imminent collision. There are many other potential applications.

ADAS applications may rely on a predictive ability based in part on the creation of ADAS horizons. An ADAS horizon is an electronic map of the area surrounding a vehicle. An ADAS horizon may be derived at least in part from a full electronic map of the type used for portable navigation devices (PNDs), but it only contains information that may be relevant to ADAS. There is therefore typically no need for an ADAS horizon to contain information on street names, points of interest and 3D building representations for example. On the other hand information on speed limits, road curvature and lane information are all suitable for inclusion in an ADAS horizon and in a typical implementation would be included.

ADAS horizons are created by an horizon generator that may be associated with a PND. The horizon is provided via a communication bus in the vehicle to one or more ADAS applications which can use the horizon (in some cases together with sensor data) to provide vehicle user assistance.

Currently electronic map creation processes start with creation of a spatial reference layer by digitizing the road network from existing maps, from imagery, from processing vehicle position traces, from traces and imagery of dedicated survey vehicles (mobile mapping vans/cars), etc. The attribution of this road network is the second step of the map creation process and source information is retrieved from other databases (e.g. postal codes), maps, imagery, vehicle probes, mobile mapping vehicles, reports of surveyors and map users, etc.

Where the checking on map accuracy is required inspection is mainly carried out by experts and map users comparing real world situation with information as presented in the map.

### SUMMARY OF THE INVENTION

According to a first aspect of the invention an electronic map error detection process is provided comprising the steps of:
1) Obtaining a local electronic map by means of a communication system, the local electronic map having been generated by means of a horizon generator in a vehicle and output to the communication system, the horizon generator having used a source electronic map and vehicle position data from a vehicle positioning system to generate the local electronic map;
2) Comparing at least part of the local electronic map obtained with a part of the source electronic map having an area in common with the at least part of the local electronic map, the comparison being performed by an error detection unit;
3) Outputting an indication as to the consistency between the at least part of the local electronic map and the part of the source electronic map.

Any inconsistencies between the at least part of the local map and the part of the source electronic map will highlight an error. The error may be caused by one or more of several factors including errors in map matching (the placing of the vehicle on the source electronic map, typically within a Satellite Navigation System), errors in the communication system and errors in the vehicle positioning data. Once an error has been detected an investigation into the cause may be undertaken and where appropriate an update or upgrade performed to rectify the error. In this way improvements in the accuracy of map matching, vehicle positioning data and the performance of communication systems can be made. Additionally any inconsistencies may indicate that any application utilising the local electronic map might perform poorly, inaccurately or even dangerously; it will be appreciated that such local electronic maps may be utilised in an ADAS system which can perform safety critical tasks. Once the error has been identified appropriate remedial action may be taken.

Thus, embodiments of the system should be able to compare, at least part of, the source map with the local electronic map. As such, the source map can be automatically checked with how it is perceived by applications. By doing this continuously and aggregating information from many vehicles, an instance of the original source map can be build up again, enabling a consistent and large scale comparison between original and image. This process can be fully automatic and continuous which has a large benefit over manual effort to achieve the same.

The local electronic map may be what is termed a local horizon map. Reference hereinafter to a local horizon map may be thought of as a local electronic map.

For convenience in further discussions concerning the first aspect reference will be made to a local horizon map. It will be appreciated however that this could also be a reference to a part of a local horizon map.

Typically in the discussion below steps 1) and/or 2) may be performed more often than step (3).

In some embodiments at least some of, but may be each of, steps 1) to 3) are repeated when the horizon generator generates a new local horizon map. In this way the area in common between the local horizon map and the source electronic map may vary allowing additional error detection.

In some embodiments the horizon generator updates a previously generated local horizon map and at least some of, but may be each of, steps (1) to (3) are repeated for at least the updated portion. This may be more efficient than creating multiple local horizon maps. Additionally it may allow continuous updates or updates which occur from time to time (perhaps periodically) of the local horizon map allowing real time or near real time error detection. It will be appreciated that the updated portion may relate to a different area to the area forming the previously generated local horizon map.

In some embodiments at least some of, but may be each of, steps (1) to (3) are repeated for the updated portion only. By transmitting only changes to the local horizon map the data quantity and so processing requirements may be kept lower. This may also reduce the likelihood of overloading any of the components in the communication system and/or the error detection unit, reduce bandwidth requirements, etc.

In some embodiments the local horizon map is encoded into a data stream by means of an encoding processor following its generation by the horizon generator. In this case it may be that the local horizon map is obtained in the form of this data stream. The encoded data stream may be more easily handled by the communication system and may also be suitable for applications requiring use of the local horizon map.

In some embodiments meta-data is added to the data stream. The meta-data may indicate when the local horizon map was generated and/or its source. Further, the meta-data may include any other information such as the name of the map provider, a map release, units (e.g. speed, distance, etc.), a country/region code, driving side, etc.

In some embodiments the error detection unit comprises an error detection processor arranged to compare the local horizon map with the part of the source electronic map.

In some embodiments the error detection unit comprises a decoding processor. This may be used to decode the data stream before it is processed by the error detection processor.

In some embodiments following the generation of the local horizon map it is stored by means of a vehicle storage medium, in encoded or non-encoded form. The vehicle storage medium may allow data to be collected even where instant communication is not possible and/or desirable.

In some embodiments the vehicle storage medium stores local horizon maps generated in a predetermined period. At the completion of that period the local horizon maps may be obtained by means of the communication system. This may help to ensure that any relevant local horizon maps generated are obtained at intervals; i.e. from time to time, which may be at periodic intervals.

In some embodiments the vehicle storage medium stores local horizon maps generated until a predetermined quantity of information is stored. The local horizon maps may be obtained by means of the communication system once the predetermined quantity of information has been obtained. This may help to ensure that no local horizon maps are obtained before a quantity of data has been collected that is considered worthy of processing.

In some embodiments the vehicle storage medium stores local horizon maps generated for a predetermined travel distance of the vehicle. At the completion of that distance local horizon maps may be obtained by means of the communication system. This may help to ensure that data relevant to localised areas of the source electronic map are processed together.

In some embodiments the error detection unit comprises an error detection unit storage medium arranged to store local horizon maps obtained by the communication device. The storage may occur prior to the comparison being performed by the error detection processor. The error detection storage medium may therefore allow data to be stored for processing or otherwise even where instant processing is not possible and/or desirable.

In some embodiments the error detection unit is positioned remotely from the vehicle. This may be advantageous where the error detection unit would be too expensive or cumbersome to provide with each vehicle.

In some embodiments the communication system comprises a communication bus and a transmitter which transmits the local horizon map after it has been encoded.

In some embodiments the communication bus has additional functions within the vehicle. The communication bus may for example form part of an audio bus in the vehicle. In general it is preferred that the bus is selected so as not to be critical to the performance of the vehicle (in the way that engine and suspension buses are for example). In this way the risk of overload or interference with a critical bus is reduced. The bus may for example be a CAN bus (Controller Area Network bus).

In some embodiments the communication system further comprises a receiver arranged to receive the data stream transmitted by the transmitter.

In some embodiments transmitting the data stream from the transmitter to the receiver occurs via one or more road side units or other storage and/or retransmission hubs.

Road side units may allow additional data to be collected and stored. Moreover, embodiments using such road side units may provide more efficient bandwidth utilisation when compared with wider area transmission techniques such as 3G networks and the like.

In some embodiments local horizon maps are generated in more than one vehicle and are obtained by means of the communication system such that the error detection unit receives local horizon maps from more than one vehicle. This has the potential to allow local horizon maps relevant to large parts if not all of the source electronic map to be received simultaneously. It will be appreciated that this may greatly increase the speed and efficiency with which error detection is performed.

In embodiments where local horizon maps are generated in more than one vehicle the communication system may comprise elements in each vehicle elements in one or more locations remote from the vehicles.

In some embodiments an additional step of patching together two or more local horizon maps is performed so as to expand the area in common of the patched horizons with the part of the source electronic map. This may allow overlapping or abutting local horizon maps (regardless of their vehicle of origin) to be combined to create a horizon covering a larger area for use in comparison with the part of the source electronic map.

In some embodiments an additional step of aggregating local horizon maps that relate to the common area is performed and this aggregate is used as the horizon in the comparison with the part of the source electronic map. By taking the mean of the local horizon maps in this way their accuracy may be increased and isolated insignificant errors may be ignored. This increased accuracy may lead to a more useful comparison being performed with the part of the source electronic map.

In some embodiments aggregated local horizon maps are patched together. This has the potential to combine the benefits of aggregation and patching as described above.

In some embodiments the local horizon map is an ADAS horizon. ADAS horizons are already known and are generated in vehicles from suitable source electronic maps. Detecting errors concerning the generation of ADAS horizons is clearly highly desirable in view of ADAS horizons being used by ADAS applications designed to increase driver safety.

In some embodiments the vehicle further comprises one or more ADAS applications.

In some embodiments feedback from one or more of the ADAS applications is used to add additional information to and/or correct information in the local horizon map before it is obtained by means of the communication system. Since the feedback may be based upon data concerning what actually happens to the vehicle it has the potential to significantly increase the accuracy of the encoded data stream. In this way not only can errors in map matching, errors in the communication system and errors in the vehicle positioning data be detected but further errors in the part of the source electronic map may also be detected.

In alternative embodiments the feedback is obtained by means of the communication system and is used to add additional information to and/or correct information in the local horizon map during processing by the error detection processor.

In some embodiments the vehicle further comprises one or more sensors. These may for example monitor road sign information, vehicle speed, braking, acceleration or cornering etc.

In some embodiments information obtained via one or more of the sensors is used to add additional information to and/or correct information in the local horizon map before it is obtained by means of the communication system. Since the information would be based upon real world data collected it has the potential to significantly increase the correctness and accuracy of the local horizon map.

In alternative embodiments the additional information is obtained by means of the communication system and is used to add additional information to and/or correct information in the local horizon map during processing by the error detection processor.

It may be that the encoding processor encodes the local horizon maps according to a standard or proprietary protocol.

It may be that the standard protocol is defined by the European Advanced Driver Assistance Systems Interface Specification (ADASIS) forum.

In some embodiments one or more of the vehicles may be provided with an example of the error detection unit. Local error detection of this nature may be desirable where rapid updates or warnings to the vehicle user are desirable. Where the comparison reveals a level of inconsistency that may mean that the vehicle user may be advised incorrectly, the output may warn the user and/or enable or disable a vehicle function.

In some embodiments the vehicle positioning system is a Global Navigation Satellite System (GNSS). It may for example be GPS. It will be appreciated however that any other suitable vehicle positioning system may be used.

The output device may for example be a screen, a printing device, a processor arranged to begin the process of error correction or any other suitable device.

According to a second aspect of the invention an electronic map error detection system is provided comprising:
1) a communication system arranged to obtain a local electronic map generated by means of a horizon generator in a vehicle, the horizon generator being arranged to use a source electronic map and vehicle position data from a vehicle positioning system to generate the local electronic map;
2) an error detection unit arranged to perform a comparison between at least part of the local electronic map with a part of the source electronic map having an area in common with the at least part of the local electronic map;
3) an output device arranged to indicate the consistency between the at least part of the local electronic map and the part of the source electronic map.

The local electronic map may be what is termed a local horizon map. Reference hereinafter to local horizon map may be thought of as a local electronic map.

For convenience in further discussions concerning the second aspect reference will be made to a local horizon map. It will be appreciated however that this could also be a reference to a part of a local horizon map.

In some embodiments the electronic map error detection system comprises an encoding processor arranged to encode the local horizon map into a data stream following its generation by the horizon generator. In this case it may be that the local horizon map is obtained in the form of this data stream. The encoded data stream may be more easily handled by the communication system and may also be suitable for applications requiring use of the local horizon map.

In some embodiments the electronic map error detection unit comprises an error detection processor arranged to compare the local horizon map with the part of the source electronic map.

In some embodiments the error detection unit comprises a decoding processor. This may be used to decode the data stream before it is processed by the error detection unit.

In some embodiments the electronic map error detection system further comprises a vehicle storage medium arranged to store the local horizon map following its generation, in encoded or non-encoded form. The vehicle storage medium may allow data to be collected even where instant communication is not possible and/or desirable.

In some embodiments the error detection unit further comprises an error detection unit storage medium arranged to store local horizon maps obtained by the communication device. This may be prior to the comparison being performed by the error detection processor. The error detection unit storage medium may allow data to be stored for processing even where instant processing is not possible and/or desirable.

In some embodiments the error detection unit is positioned remotely from the vehicle. This may be particularly advantageous where the error detection unit would be too expensive or cumbersome to provide with each vehicle.

In some embodiments the communication system comprises a communication bus and a transmitter which transmits the local horizon map after it has been encoded.

In some embodiments the communication bus has additional functions within the vehicle. The communication bus may for example form part of an audio bus in the vehicle. In general it is preferred that the bus is selected so as not to be critical to the performance of the vehicle (in the way that engine and suspension buses are for example). In this way the risk of overload or interference with a critical bus is reduced. The bus may for example be a CAN bus (Controller Area Network bus).

In some embodiments the communication system further comprises a receiver arranged to receive the data stream transmitted by the transmitter.

In some embodiments the communication system further comprises one or more road side units or other storage and/or retransmission hubs arranged to transmit the data stream from the transmitter to the receiver. Road side units may allow additional data to be collected and stored. The advantage of such road side units may also be that an increased bandwidth is provided.

In some embodiments more than one example of the horizon generator is provided each of which when in use may be provided in a different vehicle, such that the error detection unit receives local horizon maps from more than one vehicle. This has the potential to allow local horizon maps relevant to large parts if not all of the source electronic map to be received simultaneously by the error detection unit. It will be appreciated that this may greatly increase the speed and efficiency with which error detection is performed.

In embodiments where local horizon maps are generated in more than one vehicle the communication system may comprise elements in each vehicle elements in one or more locations remote from the vehicles.

In some embodiments the local horizon maps are ADAS horizons.

In some embodiments the electronic map error detection system further comprises one or more ADAS applications arranged to provide feedback that adds additional information to and/or corrects information in the local horizon map.

In some embodiments the electronic map error detection system further comprises one or more sensors arranged to provide information used to add additional information to and/or correct information in the local horizon map. The sensors may for example monitor road sign information, vehicle speed, braking, acceleration or cornering etc.

The output device may for example be a screen, a printing device, a processor arranged to begin the process of error correction or any other suitable device.

According to a third aspect of the invention an electronic map generation process is provided comprising the steps of:
1) Obtaining a local electronic map by means of a communication system, the local electronic map having been generated by means of a horizon generator in a vehicle and output to the communication system, the horizon generator having used a source electronic map and vehicle position data from a vehicle positioning system to generate the local electronic map;
2) Processing the local electronic map in an electronic map generation unit; and
3) Outputting an electronic map.

The electronic map generation process allows for an electronic map to be created from local electronic map data. This may be an efficient way of creating new electronic maps.

The local electronic map may be what is termed a local horizon map. Reference hereinafter to local horizon map may be thought of as a local electronic map. In some embodiments at least some of, but may be each of, steps 1) to 3) are repeated when the horizon generator generates a new local horizon map. In this way additional new areas of electronic map may be created.

In some embodiments the horizon generator updates a previously generated local horizon map and at least some of, but may be each of, the steps 1) to 3) are repeated for at least the updated portion. This may be more efficient than creating multiple local horizon maps. Additionally it may allow continuous updates or updates that occur from time to time (perhaps periodically) of the local horizon map allowing real time or near real time electronic map creation. It will be appreciated that the updated portion may relate to a different area to the area forming the previously generated local horizon map.

In some embodiments at least some of, but may be each of, the steps 1) to 3) are repeated for the updated portion only. By transmitting only changes to the local horizon map the data quantity and so processing requirements may be kept lower. This may also reduce the likelihood of overloading any of the components in the communication system and/or the electronic map generation unit.

In some embodiments the local horizon map is encoded into a data stream by means of an encoding processor following its generation by the horizon generator. In this case it may be that the local horizon map is obtained in the form of this data stream. The encoded data stream may be more easily handled by the communication system and may also be suitable for applications requiring use of the local horizon map.

In some embodiments meta-data is added to the data stream. The meta-data may indicate when the local horizon map was generated and/or its source. Further, the meta-data may include any other information such as the name of the map provider, a map release, units (e.g. speed limit), a country/region code, driving side, etc.

In some embodiments the electronic map generation unit comprises an electronic map generation processor arranged to generate electronic maps.

In some embodiments the electronic map generation unit comprises a decoding processor. This may be used to decode the data stream before it is processed by the electronic map generation processor.

In some embodiments following the generation of the local horizon map it is stored by means of a vehicle storage medium, in encoded or non-encoded form. The vehicle storage medium may allow data to be collected even where instant communication is not possible and/or desirable.

In some embodiments the vehicle storage medium stores local horizon maps generated in a predetermined period. At the completion of that period the local horizon maps may be obtained by means of the communication system. This may help to ensure that any relevant local horizon maps generated are obtained at intervals i.e. from time to time, which may be at periodic intervals.

In some embodiments the vehicle storage medium stores local horizon maps generated until a predetermined quantity of information is stored. The local horizon maps may be obtained by means of the communication system, once the predetermined quantity of information has been stored. This may help to ensure that no local horizon maps are obtained before a quantity of data has been collected that is considered worthy of processing.

In some embodiments the vehicle storage medium stores local horizon maps generated for a predetermined travel distance of the vehicle. At the completion of that distance local horizon maps may be obtained by means of the communication system. This may help to ensure that data relevant to localised areas of the source electronic map are processed together.

In some embodiments the electronic map generation unit comprises an electronic map generation unit storage medium arranged to store local horizon maps obtained by the communication device which may be prior to their processing by the electronic map generation processor. The electronic map generation unit storage medium may allow data to be stored for processing even where instant processing is not possible and/or desirable.

In some embodiments the electronic map generation unit is positioned remotely from the vehicle. This may be advantageous where the electronic map generation unit would be too expensive or cumbersome to provide with each vehicle.

In some embodiments the communication system comprises a communication bus and a transmitter which transmits the local horizon map after it has been encoded.

In some embodiments the communication bus has additional functions within the vehicle. The communication bus may for example form part of an audio bus in the vehicle. In general it is preferred that the bus is selected so as not to be critical to the performance of the vehicle (e.g. engine and suspension buses). In this way the risk of overload or interference with a critical bus is reduced. The bus may for example be a CAN bus.

In some embodiments the communication system further comprises a receiver arranged to receive the data stream transmitted by the transmitter.

In some embodiments transmitting the data stream from the transmitter to the receiver occurs via one or more road side units or other storage and/or retransmission hubs. Road side units may allow additional data to be collected and stored.

In some embodiments local horizon maps are generated in more than one vehicle and are obtained by means of the communication system such that the electronic map generation unit receives local horizon maps from more than one vehicle. The local horizon maps may is some cases have been produced by different horizon generators and/or from different source electronic maps. Use of local horizon maps from more than one vehicle has the potential to allow data streams relevant to large areas of potential new electronic map to be received simultaneously. It will be appreciated that this may greatly increase the speed and efficiency with which electronic map can be created.

In embodiments where local horizon maps are generated in more than one vehicle the communication system may comprise elements in each vehicle elements in one or more locations remote from the vehicles.

In some embodiments an additional step of patching together two or more local horizon maps is performed. This may allow overlapping or abutting local horizon maps (regardless of their vehicle of origin) to be combined to create an increased area of new electronic map.

In some embodiments an additional step of aggregating local horizon maps that relate to a common area is performed and this aggregate is processed by the electronic map generation processor. By taking the mean of the local horizon maps in this way their accuracy may be increased especially where the local horizon maps are created by different electronic horizon generators and/or using different source electronic maps. This increased accuracy may lead to more accurate electronic maps being created.

In some embodiments aggregated local horizon maps are patched together. This has the potential to combine the benefits of aggregation and patching as described above.

In some embodiments the local horizon map is an ADAS horizon. ADAS horizons are already known and are generated in vehicles from suitable source electronic maps. They therefore provide a ready resource for the generation of electronic maps.

In some embodiments the vehicle further comprises one or more ADAS applications.

In some embodiments feedback from one or more of the ADAS applications is used to add additional information to and/or correct information in the local horizon map before it is obtained by means of the communication system. Since the feedback may be based upon data concerning what actually happens to the vehicle it has the potential to significantly increase the accuracy of the encoded data stream.

In alternative embodiments the feedback is obtained by means of the communication system and is used to add additional information to and/or correct information in the local horizon map during processing by the electronic map generation processor.

In some embodiments the vehicle further comprises one or more sensors. These may for example monitor road sign information, vehicle speed, braking, acceleration or cornering etc.

In some embodiments information obtained via one or more of the sensors is used to add additional information to and/or correct information in the local horizon map before it is obtained by means of the communication system. Since the information would be based upon real world data collected it has the potential to significantly increase the accuracy of the local horizon map.

In alternative embodiments the additional information is obtained by means of the communication system and is used to add additional information to and/or correct information in the local horizon map during processing by the electronic map generation processor.

It may be that the encoding processor encodes the local horizon maps according to a standard protocol.

It may be that the standard protocol is defined by the European Advanced Driver Assistance Systems Interface Specification (ADASIS) forum. Alternatively, the protocol may be any other suitable protocol.

In some embodiments the electronic map outputted may be used to check for errors in at least part of another electronic map. This type of error checking may be particularly effective where the electronic map outputted is the result of an aggregation process of local horizon maps produced using different source electronic maps as previously discussed. In this way

The output device may for example be a screen, a printing device or a processor arranged to check for errors in the other electronic map.

According to a fourth aspect of the invention an electronic map generation system is provided comprising:
1) a communication system arranged to obtain a local electronic map generated by means of a horizon generator in a vehicle, the horizon generator being arranged to use a source electronic map and vehicle position data from a vehicle positioning system to generate the local electronic map;
2) an electronic map generation unit; and
3) an output device arranged to output an electronic map.

The local electronic map may be what is termed a local horizon map. Reference hereinafter to a local horizon map may be thought of as a local electronic map.

In some embodiments the electronic map generation system further comprises an encoding processor arranged to encode the local horizon map into a data stream following its generation by the horizon generator. In this case it may be that the local horizon map is obtained in the form of this data stream. The encoded data stream may be more easily handled by the communication system and may also be suitable for applications requiring use of the local horizon map.

In some embodiments the electronic map generation unit comprises an electronic map generation processor arranged to generate the electronic map.

In some embodiments the electronic map generation unit comprises a decoding processor. This may be used to decode the data stream before it is processed by the electronic map generation processor.

In some embodiments the electronic map generation system further comprises a vehicle storage medium arranged to store the local horizon map following its generation, in encoded or non-encoded form. The vehicle storage medium may allow data to be collected even where instant communication is not possible and/or desirable.

In some embodiments the electronic map generation unit further comprises an electronic map generation unit storage medium arranged to store local horizon maps obtained by the communication device. This may be prior to their processing by the electronic map generation processor. The electronic map generation unit storage medium may allow data to be stored for processing even where instant processing is not possible and/or desirable.

In some embodiments the electronic map generation unit is positioned remotely from the vehicle. This may be advantageous where the electronic map generation unit would be too expensive or cumbersome to provide with each vehicle.

In some embodiments the communication system comprises a communication bus and a transmitter which transmits the local horizon map after it has been encoded.

In some embodiments the communication bus has additional functions within the vehicle. The communication bus may for example form part of an audio bus in the vehicle. In general it is preferred that the bus is selected so as not to be critical to the performance of the vehicle (in that way that engine and suspension buses are for example). In this way the risk of overload or interference with a critical bus is reduced. The bus may for example be a CAN bus.

In some embodiments the communication system further comprises a receiver arranged to receive the data stream transmitted by the transmitter.

In some embodiments the communication system further comprises one or more road side units or other storage and/or retransmission hubs arranged to transmit the data stream from the transmitter to the receiver. Road side units may allow additional data to be collected and stored. Further they may allow for the power of the transmitters to be lower.

In some embodiments more than one example of the horizon generator is provided each of which when in use may be provided in a different vehicle, such that the electronic map generation unit receives local horizon maps from more than one vehicle. This has the potential to allow data streams relevant to large areas of potential new electronic map to be received simultaneously. It will be appreciated that this may greatly increase the speed and efficiency with which electronic map can be created.

In embodiments where local horizon maps are generated in more than one vehicle the communication system may comprise elements in each vehicle elements in one or more locations remote from the vehicles.

In some embodiments the local horizon maps are ADAS horizons.

In some embodiments the electronic map generation system further comprises one or more ADAS applications arranged to provide feedback that adds additional information to and/or corrects information in the local horizon map.

In some embodiments the electronic map generation system further comprises one or more sensors arranged to provide information used to add additional information to and/or correct information in the local horizon map. The sensors may for example monitor road sign information, vehicle speed, braking, acceleration or cornering etc.

According to a fifth aspect of the invention a portable navigation device (PND) is provided having an electronic horizon generator, the electronic horizon generator being arranged for use in any of the processes or systems disclosed above.

According to a sixth aspect of the invention there is provided a machine readable medium containing instructions which when read by a machine cause that machine to perform the process of the first aspect of the invention, or any one or more of the sub-processes of the first aspect, perform the process of the third aspect of the invention, or any one or more of the sub-processes of the third aspect, cause that machine to function as the system of the second aspect or any one of the components of the second aspect, to behave as the system of the fourth aspect or any one of the components of the fourth aspect

In any of the above aspects of the invention the machine readable medium may comprise any of the following: a floppy disk, a CD ROM, a DVD ROM/RAM (including a -R/-RW and +R/+RW), a hard drive, a solid state memory (including a USB memory key, an SD card, a Memorystick™, a compact flash card, or the like), a tape, any other form of magneto optical storage, a transmitted signal (including an Internet download, an FTP transfer, etc), a wire, or any other suitable medium.

Further, the skilled person will appreciate that features discussed in relation to any one aspects of the invention are suitable, mutatis mutandis, for other aspects of the invention.

The processors discussed in any of the above aspects may be provided by software and/or firmware processes running on processing circuitry.

Likewise, many of the features discussed in relation to the above aspects may be performable in software, hardware and/or firmware or indeed any combination of these.

### BRIEF DESCRIPTION OF THE FIGURES

Embodiments of the present invention will now be described by way of example only, with reference to the accompanying figures, where:

FIG. 1 is a schematic illustration of a Global Positioning System (GPS);

FIG. 2a is a schematic view of an electronic map error detection system according to one embodiment of the invention;

FIG. 2b is a flow chart showing an electronic map error detection process corresponding to the system of FIG. 2a;

FIG. 3a is a screen capture used to illustrate aggregating of ADAS horizons.

FIG. 3b is a screen capture used to illustrate patching of ADAS horizons.

FIG. 4a is a schematic view of an electronic map error detection system according to one embodiment of the invention;

FIG. 4b is a flow chart showing an electronic map error detection process corresponding to the system of FIG. 4a;

FIG. 5a is a schematic view of an electronic map generation system according to one embodiment of the invention; and

FIG. 5b is a flow chart showing an electronic map generation process corresponding to the system of FIG. 5a.

### DETAILED DESCRIPTION OF EMBODIMENTS OF INVENTION

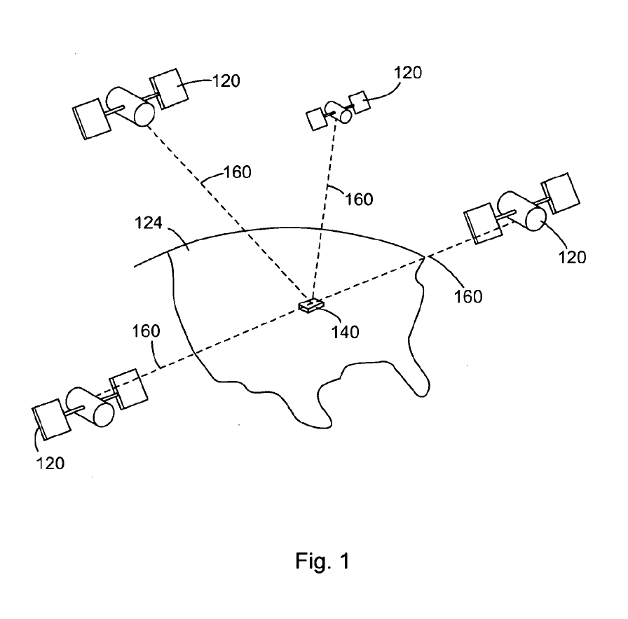

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in precise orbits. Based on these precise orbits, GPS satellites can relay their location to any number of receiving units. However, it will be understood that Global Positioning systems could be used, such as GLOSNASS, the European Galileo positioning system, COMPASS positioning system or IRNSS (Indian Regional Navigational Satellite System).

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize an accurate frequency standard accomplished with an accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

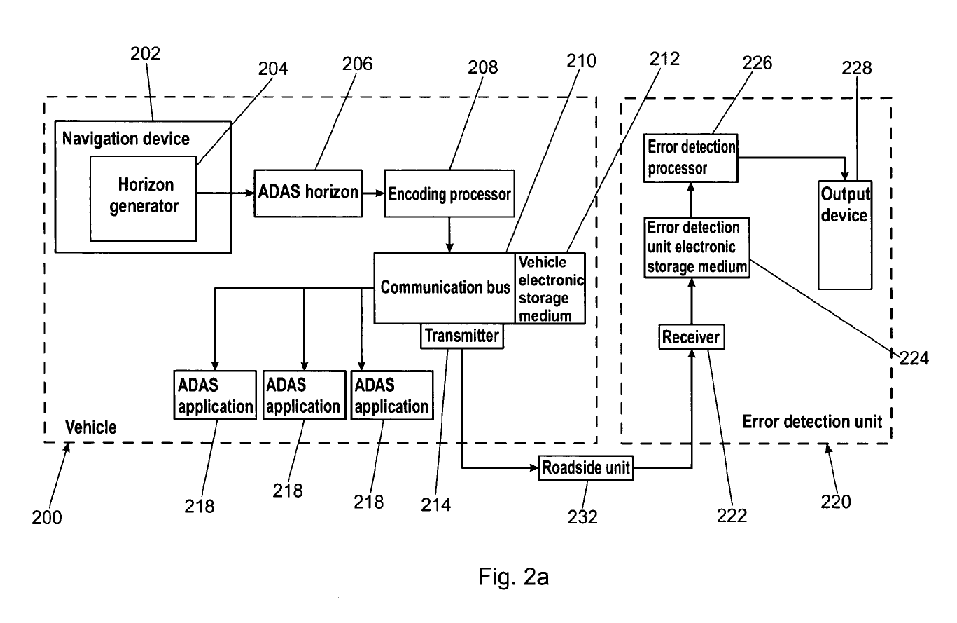

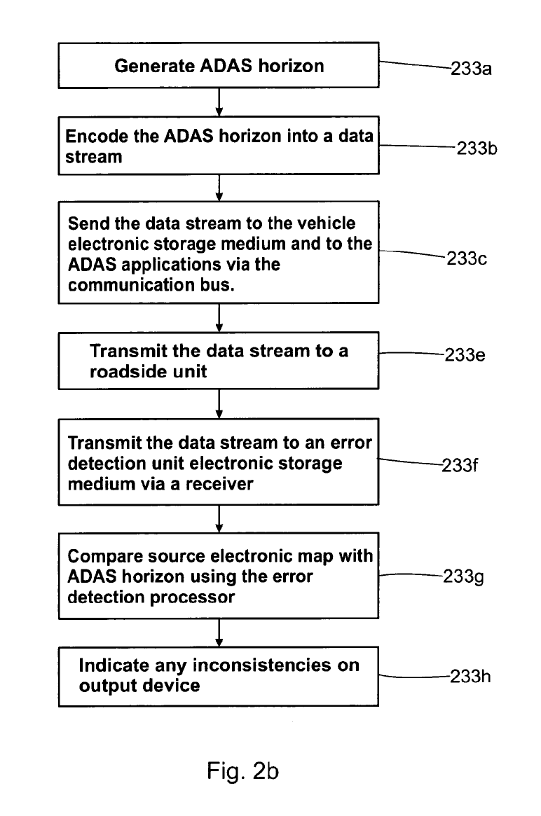

Referring now to FIG. 2a an electronic map error detection system is described. A vehicle is generally shown at 200. The vehicle is provided with a navigation device 202. The navigation device is provided in a memory (not shown) with a source electronic map. Integrated with the navigation device 202 is a horizon generator 204 arranged to generate a local electronic map (in this case an ADAS horizon 206) utilising the source electronic map and a GPS position provided by one or more satellites 120. The vehicle is also provided with an encoding processor 208. The horizon generator 204 and encoding processor 208 are communicatively linked by means of a wired connection. It will be appreciated that in the embodiments described communicative links are generally provided by wired connections, but that in other embodiments one or more wireless connections may be alternatively used. Communicatively linked to the encoding processor 208 is a communication bus 210 also provided in the vehicle 200. In this embodiment the communication bus 210 is a CAN (Controller Area Network) bus. The communication bus 210 is provided with a vehicle electronic storage medium 212 and a transmitter 214.

The vehicle 200 is also provided with three integrated ADAS application 218 that are communicatively linked to the communication bus 210.

An error detection unit is generally provided at 220. In the present embodiment the error detection unit 220 is remotely located from the vehicle 200. The error detection unit 220 is provided with a receiver 222. The receiver 222 is communicatively linked to an error detection unit electronic storage medium 224 by means of a wired connection. The error detection unit electronic storage medium 224 is communicatively linked to an error detection processor 226 by means of a wired connection. The error detection processor 226 is communicatively linked to an output device 228 by means of a wired connection.

External to the vehicle 200 and the error detection unit 220 is a roadside unit 232, which may be thought of as a repeater arranged to transmit/receive data. This is representative of potential multiple roadside units variously located. The transmitter 214 communicatively links with the roadside unit 232 by means of a wireless link. Similarly the roadside unit 232 communicatively links with the receiver 222 by means of a wireless link.

The communication bus 210, transmitter 214, roadside unit 232 and receiver 222 comprise a communication system.

The electronic map error detection system of FIG. 2a is used in the implementation of an electronic map error detection process. The electronic map error detection process takes advantage of the in vehicle components 202, 204, 208, 210, 212, 214 and 218 which are primarily provided for the purpose of implementing ADAS applications, to check for inconsistencies that may indicate errors in the placing of the vehicle on the source electronic map, errors in the communication system and errors in GPS positioning.

With use of the electronic map error detection system of FIG. 2a the electronic map error detection process is performed in the following way (see FIG. 2b).

The horizon generator 204 uses the source electronic map provided on the navigation device 202 and vehicle position data from a vehicle positioning system (in this case GPS) to generate an ADAS horizon 206 in step 233a. The ADAS horizon 206 is a projected electronic map of the area surrounding the vehicle 200 and as such may be thought of as a local electronic map. It incorporates information required by ADAS application 218 in order that they can assist the user of the vehicle 200. In particular the information relates to road topography. It typically does not however incorporate other information that is found on the source electronic map such as street names, points of interest and 3D building representations. It is therefore a more specialised type of electronic map. The ADAS horizon 206 is encoded into a data stream by the encoding processor 208 in step 233b. The protocol used for encoding the data stream is defined by the European Advanced Driver Assistance Systems Interface Specification (ADASIS) forum. ADASIS is currently an emerging industry standard for communication between horizon generators 204 and ADAS applications 218. The data stream is distributed to the ADAS applications 218 via the communication bus 210. In the particular embodiment of the vehicle 200 being described the communication bus 210 serves a more general role as an audio bus, but this need not be the case. The ADAS applications may serve any number of functions (for example collision avoidance systems, traffic sign recognition and adaptive lighting control).

In addition to distributing the data stream to the ADAS applications 218 the communication bus 210 also sends the data streams to the vehicle electronic storage medium 212 for temporary storage. Sending the data stream to the vehicle electronic storage medium 212 and to the ADAS applications 218 via the communication bus 210 is performed in step 233c. After a pre-determined time (in this case three minutes) the stored data streams in the vehicle electronic storage medium 212 are transmitted by the transmitter 214 over a wireless link to the roadside unit 232 in step 233e. The roadside unit 232 retransmits the data streams to the receiver 222 via another link which in the embodiment being described is a wireless link.

In other embodiments, the transmitter 214 may be arranged to transmit the data stream via a connection to a Wide Area Network such as the Internet. The connection may be provided by means such as a cellular data connection, for example a 3G (may be UMTS (Universal Mobile Telecommunication System) link), a WIFI, WIMAX connection or the like. In yet further embodiments, it would be possible for the transmitter to, from time to time, download the data via a wired connection when connected thereto.

The receiver 222 sends the data streams to the error detection unit electronic storage medium 224 where they await processing by the error detection processor 226. Transmitting the data stream to the error detection unit electronic storage medium 224 via the receiver 222 is performed in step 233f. In the present embodiment the vehicle 200 is an example of many similar vehicles equipped with examples of the components 202, 204, 208, 210, 212, 214 and 218. Consequently the error detection unit electronic storage medium 224 stores many data streams from different vehicles. Most if not all of these data streams are for ADAS horizons 206 that have at least part of their area in common with at least one other ADAS horizon having a data stream in the error detection unit electronic storage medium 224. Consequently the error detection processor 226 can patch together separately generated ADAS horizons to produce larger ADAS horizons covering larger mapping areas. Additionally many similar or identical ADAS horizons may be obtained when vehicles transmitting ADAS horizons follow similar paths to other vehicles that have also transmitted ADAS horizons. Consequently the error detection processor 226 can aggregate these horizons such that accuracy is increased. In this way isolated anomalous examples of inaccurate ADAS horizons may become statistically insignificant and therefore largely ignored by the error detection processor.

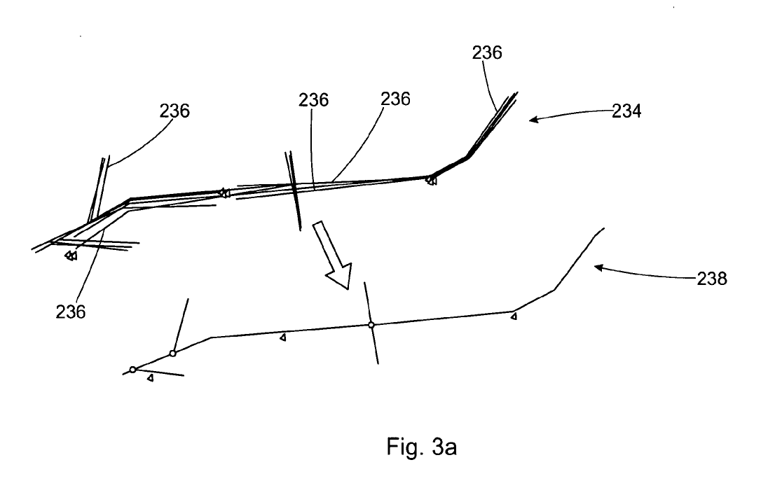

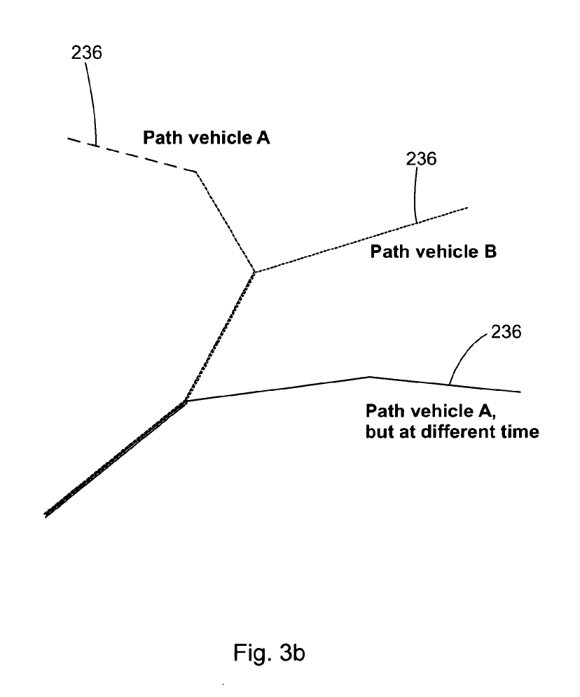

An illustration of the way in which aggregation might be achieved can be seen with reference to FIG. 3a. Here, shown in a pre-aggregated state 234 are multiple ADAS horizons that have been overlaid for a common map area. In this case each horizon can be seen by reference to its predictions 236 indicating a surrounding road network. As can be seen, although a feeling for the true road network can be obtained from the pre-aggregated state 234, the predictions 236 do not entirely agree. This for example be because the ADAS horizons have been generated using different source electronic maps of varying accuracy, or because of errors in the communication of some ADAS horizons. In a post-aggregated state 238 however, a best fit has been taken of all relevant horizons (and so predictions 236). This gives an indication of the true road network that on average will be more likely to be accurate than the indication provided by any randomly selected horizon.

An illustration of the way in which patching might be achieved can be seen with reference to FIG. 3b. As before multiple ADAS horizons (in this case being produced by two different vehicles, A and B) have been overlaid for a given map area.

As can be seen vehicle A and vehicle B have produced ADAS horizons making predictions 236 relevant to sub areas within the given map area. This is because they have travelled on different parts of the road network. The predictions 236 relating to different sub areas are however adjacent and can therefore be patched together in order to produce a larger overall map area (the given map area). As will be appreciated adjacent ADAS horizons can be patched together regardless of whether they are created by different vehicles or the same vehicle at different times.

In the penultimate stage 233g of the electronic map error detection process a part of the source electronic map having an area in common with the patched and aggregated ADAS horizon is compared to the patched and aggregated ADAS horizon by the error detection processor 226. In order for the area in common of both maps to be identified the two maps need to be spatially aligned. This can be achieved via network matching. This may include looking for characteristic features such as intersections or curviness of road segments in order to spatially align maps. Once the part of the source electronic map and the patched and aggregated ADAS horizon have been spatially aligned, the comparison can proceed. The comparison may for example involve comparing map attributes the position of map features. Additionally spatial offsets from intersections or nodes in the map may be processed. The error detection processor 226 sends the results of the comparison to the output device 228 which indicates any inconsistencies and the degree of each inconsistency in step 233h. Following this an investigation may be undertaken to establish the cause of the inconsistency and remedial action taken.

It will be appreciated that in this embodiment the comparison might highlight an error where the error has been caused by the vehicle 200 having been incorrectly positioned on the source electronic map (ie an error in map matching), or errors arising from inaccuracies in GPS positioning, or errors in encoding/decoding or errors in communication.

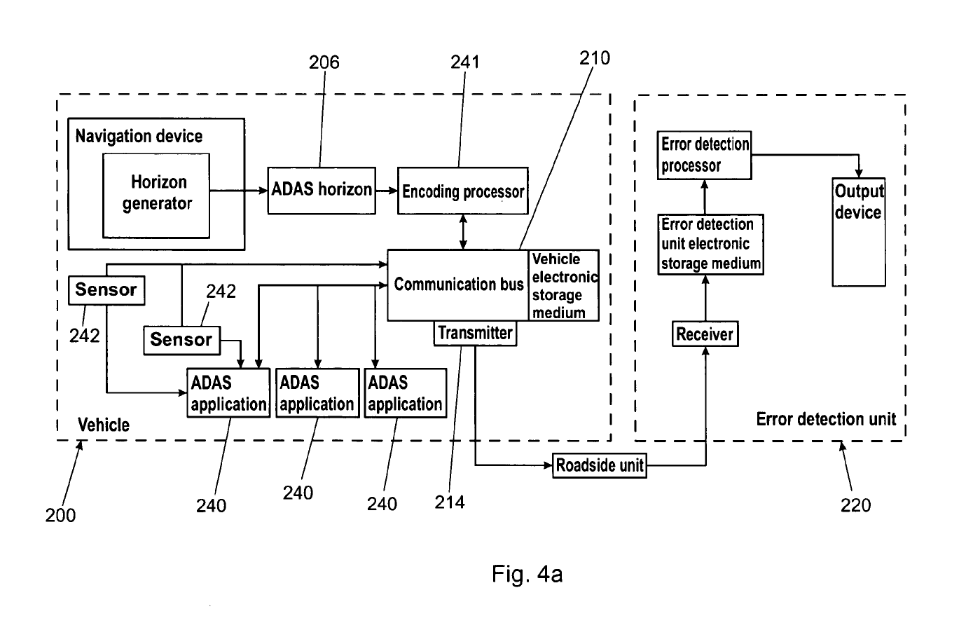

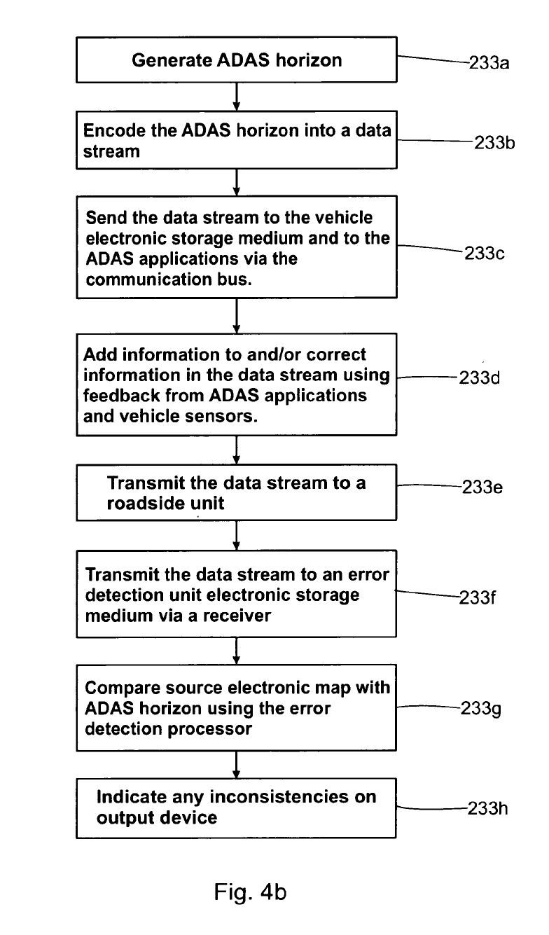

Referring now to FIG. 4a an alternative electronic map error detection system is shown. This system is in many ways similar to the system of FIG. 2a and like reference numerals have therefore been employed where appropriate for like components. Only differences in the two systems are described.

In the electronic map error detection system of FIG. 4a the ADAS applications 240 now comprise part of the error detection system in the sense that they are capable of providing feedback to the encoding processor 241 via the communication bus 210. A pair of vehicle sensors 242 have also been added to the electronic map error detection system. The sensors 242 provide information to one of the ADAS applications 240 but also are capable of providing information to the encoding processor 241 via the communication bus 210. In this embodiment the encoding processor 241 is capable not only of encoding the ADAS horizon 506 but also of modifying its content to increase its accuracy in view of the real world data supplied by the ADAS applications 240 and sensors 242. It will be appreciated that in other embodiments an alternative processor may be used to perform these tasks.

A process employing the error detection system of FIG. 4a is shown in FIG. 4b. Feedback from the ADAS applications 240 is used to add additional information to and/or correct information in the encoded data stream before it is transmitted. Since the feedback is based upon data concerning what actually happens to the vehicle 200 it has the potential to significantly increase the correctness and accuracy of the encoded data stream.

The information provided by the sensors 242 is based on real-world observation and this may be a data supplement for the ADAS application 240. Additionally because the sensors 242 can provide information to the encoding processor 241 they too can be used to add additional information to and/or correct information in the encoded data stream. Again, because the information would be based upon real world data collected, it has the potential to increase the accuracy of the encoded data stream.

Adding information to and/or correcting information in the data stream using feedback from the ADAS applications 240 and vehicle sensors 242 is performed in step 233d.

The modifications described in relation to the electronic map error detection system of FIG. 4a allow for an added dimension to the error detection performed by the error detection processor 226. Not only can errors relating to map matching, GPS positioning, encoding/decoding, communications and the like be detected, but also it will be appreciated that the ADAS horizon processed by the error detection system 226 may be more accurate than the source electronic map in view of the real world observations provided by the ADAS applications 240 and sensors 242. This may be especially true where the ADAS horizon processed has also been patched and/or aggregated. Consequently errors in the source electronic map may also be detected (and ultimately corrected).

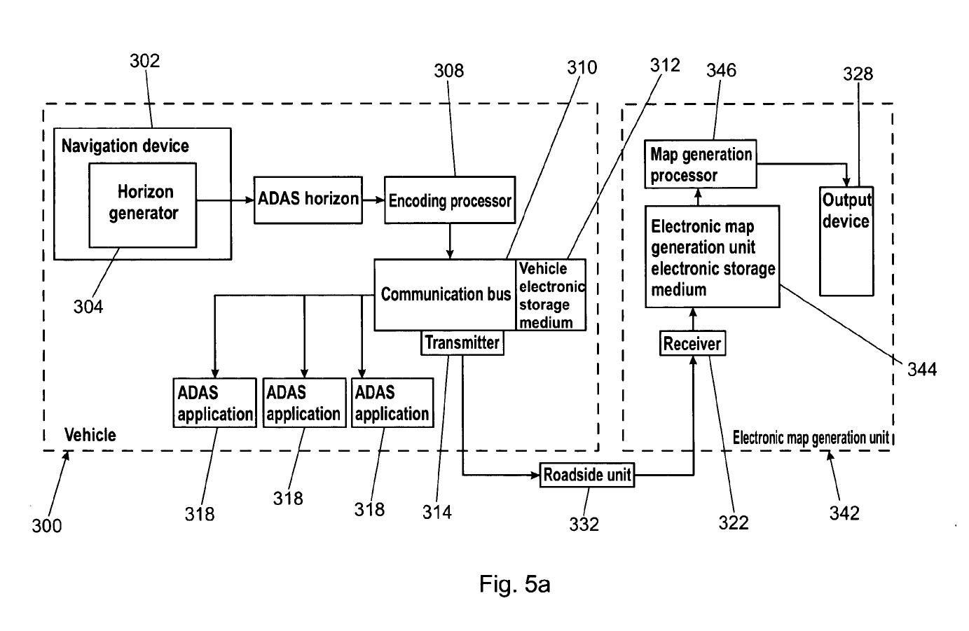

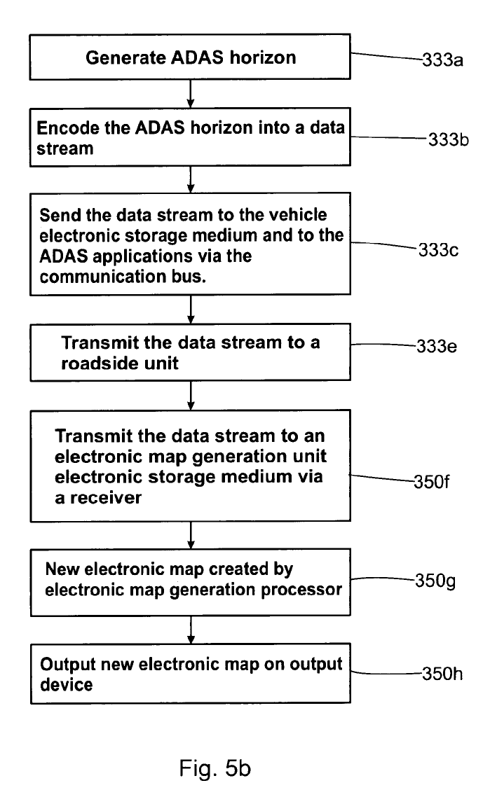

Referring now to FIG. 5a an electronic map generation system is shown. This system bears some similarity to the error detection system of FIG. 2a. Consequently like reference numerals for like components are used in the series 300. In this embodiment of an electronic map generation system the components 302, 304, 308, 310, 312, 314 and 318, and 332 are identical to those used in the error detection system of FIG. 2a. There is however no error detection unit 220, it instead being replaced with an electronic map generation facility 342.

In the present embodiment the electronic map generation facility 342 is remotely located from the vehicle 300, but in other embodiments it may be located within the vehicle 300. The electronic map generation facility 342 is provided with a receiver 322. The receiver 322 is communicatively linked to an electronic map generation unit electronic storage medium 344 by means of a wired connection. The electronic map generation unit electronic storage medium 344 is communicatively linked to an electronic map generation processor 346 by means of a wired connection. The electronic map generation processor 346 is communicatively linked to an output device 328 by means of a wired connection.

The roadside unit 332 is external to the vehicle and the electronic map generation unit 342. This is representative of potential multiple roadside units variously located. The transmitter 314 communicatively links with the roadside unit 332 by means of a wireless link. Similarly the roadside unit 332 communicatively links with the receiver 322 by means of a wireless link.

The electronic map generation system of FIG. 5a is used in the implementation of an electronic map generation process. The electronic map generation process takes advantage of the in vehicle components 302, 304, 308, 310, 312, 314 and 318 which are primarily provided for the purpose of implementing ADAS applications, to generate new electronic map in the ADAS horizon form.

With use of the electronic map generation system of FIG. 5a the electronic map generation process is performed in the following way (see FIG. 5b).

Until the decoded ADAS horizon reaches the electronic map generation unit electronic storage medium 344 in the electronic map generation unit 342, the process in this embodiment is identical to that described in relation to FIG. 2a. The step of transmitting the data stream to the electronic map generation unit electronic storage medium 344 via the receiver 322 is performed in step 350f.

Once the ADAS horizon reaches the storage it is sent with other similar horizons from other vehicles to the electronic map generation processor 346 where ADAS horizons are patched and aggregated as previously described (helping with the generation of more extensive and more accurate maps) and a new electronic map is created (step 350g) and sent to the output device 328 (step 350h) for use. In this case the ADAS horizons patched and aggregated were produced in vehicles where different source electronic maps were used. The outputted electronic map is therefore an amalgamation of ADAS horizons produced from different source electronic maps and may therefore be more accurate than any of the source electronic maps. In this embodiment the outputted map is used for cross-checking with another electronic map different from at least one of the source electronic maps used in the creation of the ADAS horizons.

The skilled person will appreciate that, in other embodiments, that some of the wired links discussed above may be provided by wireless links and vice versa.

1. An electronic map generation process is provided comprising the steps of:
obtaining a local electronic map via a communication system, the local electronic map having been generated by a horizon generator in a vehicle and output to the communication system, the horizon generator having used a source electronic map and vehicle position data from a vehicle positioning system to generate the local electronic map;
processing the local electronic map in an electronic map generation unit; and
outputting an electronic map.

2. The electronic map generation process according to claim 1 where the electronic map generation unit is positioned remotely from the vehicle.

3. The electronic map generation process according to claim 1 where the electronic map generation unit comprises an electronic map generation processor arranged to generate electronic maps.

4. The electronic map generation process according to claim 1 where an additional step of patching together two or more local electronic maps is performed.

5. The electronic map generation process according to claim 3 where an additional step of aggregating local electronic maps that relate to a common area is performed and this aggregate is processed by the electronic map generation processor.

6. The electronic map generation process according to claim 1 where the local electronic map is an ADAS horizon.

7. The electronic map generation process according to claim 1 where the electronic map outputted is used to check for errors in at least part of another electronic map.

8. An electronic map generation system is provided comprising:
a communication system arranged to obtain a local electronic map generated by means of a horizon generator in a vehicle, the horizon generator having used a source electronic map and vehicle position data from a vehicle positioning system to generate the local electronic map;
an electronic map generation unit; and
an output device arranged to output an electronic map.

9. An electronic map error detection process is provided comprising the steps of:
obtaining a local electronic map from a communication system, the local electronic map having been generated by a horizon generator in a vehicle and output to the communication system, the horizon generator having used a source electronic map and vehicle position data from a vehicle positioning system to generate the local electronic map;
comparing at least part of the local electronic map obtained with a part of the source electronic map having an area in common with the at least part of the local electronic map, the comparison being performed by an error detection unit; and
outputting an indication as to the consistency between the at least part of the local electronic map and the part of the source electronic map.

10. The electronic map error detection process according to claim 9 where the error detection unit is positioned remotely from the vehicle.

11. The electronic map error detection process according to claim 9 where an additional step of patching together two or more local electronic maps is performed so as to expand the area in common of the patched local electronic maps with the part of the source electronic map.

12. The electronic map error detection process according to claim 9 where an additional step of aggregating local electronic maps that relate to the common area is performed and this aggregate is used as the local electronic map in the comparison with the part of the source electronic map.

13. The electronic map error detection process according to claim 9 where the local electronic map is an ADAS horizon.

14. An electronic map error detection system is provided comprising:
a communication system arranged to obtain a local electronic map generated by means of a horizon generator in a vehicle, the horizon generator having used a source electronic map and vehicle position data from a vehicle positioning system to generate the local electronic map;
an error detection unit arranged to perform a comparison between at least part of the local electronic map with a part of the source electronic map having an area in common with the at least part of the local electronic map; and
an output device arranged to indicate the consistency between the at least part of the local electronic map and the part of the source electronic map.

15. A machine readable medium containing instructions which when read onto a machine to perform the process of claim 1.

16. The electronic map error detection process according to claim 11 where an additional step of aggregating local electronic maps that relate to the common area is performed and this aggregate is used as the local electronic map in the comparison with the part of the source electronic map.

17. A machine readable medium containing instructions which when read onto a machine to perform the process of claim 9.
